(19) United States
(12) Patent Application Publication
(10) Pub. No.: US 2018/0171675 A1
(43) Pub. Date: Jun. 21, 2018

(54) Gravity operated two-way gate latch

(71) Applicant: Nathan McGrand, Calimesa, CA (US)

(72) Inventor: Nathan McGrand, Calimesa, CA (US)

(21) Appl. No.: 15/842,882

(22) Filed: Dec. 15, 2017

Related U.S. Application Data
(60) Provisional application No. 62/435,472, filed on Dec. 16, 2016.

(51) Int. Cl. E05B 65/00; E05C 5/00

(52) U.S. Cl. CPC E05B 65/0007; E05C 5/00

(57) ABSTRACT

A symmetrical gravity operated gate latch for fastening a two-way gate and arranged to be manually released easily from either side of the closed gate to permit swinging movement and opening of the gate in either direction. The latch is mounted at the intersection of a gate's horizontal cross support tube and the vertical tube furthest from the hinges using two carriage bolts. Only a crescent wrench is needed for mounting the latch on the gate. No components are required to be mounted onto the gate post to engage the latch. To open a gate the latch is lifted until its base clears the horizontal cross support tube at which time the gate may be opened by pushing or pulling. When the gate is opened indents at the base of the latch encourage the latch to be in a proper position to engage the gate post as the gate is closing. Once the gate is opposite the gate post the latch will drop thus securing the gate. Provisions have also been made to prevent the latch from being lifted by clever animals and its theft by humans.

### CROSS-REFERENCE TO RELATED APPLICATIONS

This application claims priority from U.S. Provisional Patent Application No. 62/435,472 filed on Dec. 16, 2016. The entire disclosure of the prior application is considered to be part of the disclosure of the accompanying application and is hereby incorporated by reference.

### BACKGROUND OF THE INVENTION

### 1. Field of the Invention

The field of the present invention relates generally to gravity-type gate latches that are utilized to control ingress and egress into an area that is accessed through a gate that laterally pivots relative to an upright gate post. In particular, the present invention relates to such gravity gate latches that can be manually unlatched from either side of the gate and upon closing the latch will latch itself by gravity.

### 2. Description of the Related Art

In general, gates are installed to provide closure of a passage way which dictates the requirement for a device for securing the gate in a closed position. Most gate securing devices have mechanisms for latching, unlatching, locking and unlocking the gate in a closed position. Numerous gate securing devices have been designed and marketed that provide, in part, various degrees of latching, unlatching, locking and unlocking capabilities. Some gate securing devices are designed to only latch and unlatch a gate in which some of these can be controlled from each side of the gate. While other gate securing devices provide various degrees of latching, unlatching in combination with locking and unlocking, their parameters of operator control are limited.

U.S. Pat. No. 6,471,261 issued Oct. 29, 2002 to Messler discloses a latching apparatus in which a first connecting member is attached to a first attachment structure and a latching member is pivotally attached to a second connecting member and a second attachment structure insertion of securing mechanisms into a strategically position securing apertures prohibits disengagement and travel of a structure secured by the improved latching apparatus. Removal of either one of two said securing mechanisms from either side of a previously secured structure facilitates disengagement and travel of said previously secured structure. While this latching apparatus provides for latching, unlatching, locking and unlocking a gate, it has significant disadvantages, namely (1) the latch requires two locks, one on both sides of the gate, in order to secure the gate, (2) when the gate is secured, if operator rants to pass through the gate and re-secure the gate on the opposite side, a four step process is required to unsecure and then re-secure the gate, namely, (a) remove a near side lock and pass through gate, (b) remove a farside lock, (c) replace the nearside lock and close the gate and (d) replace the farside lock, (3) by simply unscrewing the fastening means, the latching apparatus can be disassembled while locked thus defeating the locked condition and (4) if the first connecting member of the gate latch has to be on a certain side of either a left or right hand gate then the latching apparatus may have to be disassembled, the second connecting member reversed and the latching apparatus reassembled.

U.S. Pat. No. 6,425,612 issued Jul. 30, 2002 to Schaeffer discloses a latching apparatus consisting of a housing that is attached to the gate post containing two hanging flaps suspended over a passage. A striker bar is mounted to the gate opposite the housing positioned so that the striker bar travel through the passage in the housing. When the striker bar enters the housing the first flapper is pushed open by the striker bar but the second flapper prevents the striker bar from exiting the passage. To open the gate the user must press against the flapper on their side of the gate so that the flapper is high enough for the striker bar to exit the housing. Although the Schaeffer device is less complex than the Messler device it still contains multiple components, the housing must be attached to a rectangular gate post, and it may be difficult for a user with gloves on to insert a finger into the house and lift a flapper to the position it needs to be to allow the striker bar to exit from the housing.

U.S. patent publication 2010/0156119 published Jul. 24, 2010, to Mueller et al. discloses a latching apparatus similar to the Schaeffer latch. The Mueller latch also consists of a housing that includes a plate section that moves vertically and rests on a curved ledge. The plate section contains a notch at its center. A striker bar is mounted to the gate opposite the housing and when the gate is closed the striker bar comes into contact with the plate section and by the force of momentum the striker bar will lift the plate section only to have the plate section drop down when the striker bar reaches the notch in the center of the plate section. The plate section may be easily lifted by a user by pulling on a hooks position at the top of the plate section. Although the Mueller device is less complex than the Messler latch and it is easier for a user to release the striker bar than the Schaeffer latch it is still costly to manufacturer, may be manipulated by clever animals as the hooks are exposed, requires careful installation to align the housing with the striker bar.

U.S. patent publication 2017/0321460 published Nov. 9, 2017, to Siebert discloses a latching apparatus that consists of a housing mounted to a rectangular gate post and a striker bar mounted to a gate. The housing consists of a pair of side plates that holds a center “hook” plate. When a gate is closed the striker bar enters a slot in the housing and the momentum of the striker bar lifts the center hook plate. Once the striker bar traverses the slot the center plate, by gravity, will drop and thus secure the striker bar in the housing. The open the gate the user will pull upwards on extensions exposed by the hook plate to lift the hook plate and thus allowing the striker bar to be released. Like the earlier disclosers the Siebert disclosure is complex consisting of three metal plates with a center plate that must move independently from the two side plates. As with the earlier latches the housing and the striker bar must be aligned with each other when installing the Siebert device.

U.S. patent publication 2016/0326782 published Nov. 10, 2016, to Bledsoe discloses a latching apparatus that unlike the others previously mentioned does not require a striker bar to be installed on the gate and thus simplifying the installation thereof. The latch comprises a backplate, a lock lever and a latch member. The lock lever is operable by a user to unlock the latch assembly such that the latch member is free to rotate relative to the backplate and allow a gate to be opened. The lock lever is attached to the backplate and is free to move relative to the backplate for operation of the latch assembly. The latch member is attached to the backplate and is free to move relative to the backplate while the latch assembly is in an unlocked configuration, but is prohibited from to moving relative to the backplate by the lock lever while the latch assembly is in a locked configuration. However just as in the previous disclosures the Bledsoe latch must also be attached to a rectangular gate post and it is comprised of a number of components.

U.S. patent publication 2008/0098658 published May 1, 2008, to Niazy discloses a latching apparatus that unlike the others previously mentioned is designed to be mounted onto a circular gate port. Like the Bledsoe disclosure Niazy does not require the installation of a striker bar onto the gate thus simplifying the installation thereof. However, of the disclosures mentioned thus far, the Niazy disclosure is the most complex easily containing more than three times the number of parts.

Known two way gravity latches are (1) difficult to installs as they require, for the most part, a striker bar to be installed on the gate and aligned with a housing that is installed on the gate post, (2) require, for the most part, the use of a rectangular gate post, (3) are prone to failure as they are comprised of multiple parts, and (4) costly to manufacture as multiple machining operations are required for fabrication of the latch, and (5) are difficult to operate by the user especially if the user is wearing thick gloves.

### BRIEF SUMMARY OF THE INVENTION

The gravity gate latch of the present invention provides the benefits and solves the problems identified above. That is to say, the gravity gate latch of the present invention is configured to be utilized with a gate which laterally pivots relative to a gate post so as to automatically secure the gate in a closed position and to easily and conveniently allow a person to move the gate to its open position. More specifically, the gravity gate latch of the present invention allows a person to operate the gate latch from both sides of a gate thereby eliminating the need to walk around to unlock the gate latch or to provide a string, cord, wire or other elongated member to open the gate latch. In a preferred configuration, the gravity gate latch of the present invention is structured and arranged to be attached to the far end of the gate opposite of the hinges that is to be secured by the latch of the present invention.

The primary benefit of the latch of the present invention is its simplicity of use. To open a gate the user simply lifts the latch and pushes outward on the gate. The latch will toggle to a rest position as the gate opens. To close the gate the user will push the gate toward its normally closed position. As the gate approaches the gate post the latch, in its rest position, will engage the post and once the gate is opposite the post the latch will drop due to gravity into the lock position ready to be lifted when the gate needs to be opened again. Riders on horseback may easily lift the latch regardless of the thickness of the gloves they are wearing without having to fumble about for any hooks or extensions to lift up the latch as with previous disclosures.

Another benefit of the latch of the present invention is its ease of installation. The latch is contained in a single unit that is mounted with two bolts at the far end of the gate opposite to the hinges. The latch does not need to be aligned with any related mechanism that is to be installed on the gate post. The latch requires only a single tool for installation, a ½ crescent wrench, which may easily be completed in less than a handful of minutes. The only requirement for installation is that the gate have at least one cross tube for the latch to sit on. Two different embodiments of the latch provides for engaging gate posts that are cylindrical or rectangular and up to four inches in diameter if cylindrical or on a side if rectangular.

Another benefit of the latch of the present invention is its ease of manufacture. It will be shown that the latch is manufactured by cutting a single pattern on a sheet of steel, or whatever metal it is to be made from, and then bending the pattern about its center into a shape of a U when viewed from the top or bottom. This simplicity in manufacturing lowers the cost of fabrication and reduces failures on the field to basically zero. The remaining parts are two stock carriage bolts and two cap nuts used to secure the carriage bolts.

Finally, the latch of the present invention may be locked to the gate or gate post by a padlock with a longer shank to secure the latch from theft or the gate from being opened. In addition, a simple carabiner may be clipped to the latch to prevent the latch from being lifted by clever animals who may then leave the area enclosed by the gate and its associated fence.

The gate latch of the present invention effectively addresses at least many of the problems associated with prior art gate latches. It is extremely simple to use and may be easily, manipulated by users wearing thick gloves or on horseback and allows the gate to be opened with a single hand. Once the gate is opened the latch rests on a gate's cross tube in such a manner as to engage the gate post when the gate is closed. The gate may be closed by simply creating enough momentum by kicking or pushing the gate closed so that the latch is able to engage the gate post installation only requires a single tool and may be accomplished in just a few minutes. Finally, the latch fabricated from a single cut pattern of steel which is then bent into shape thus lowering the cost of manufacture and reducing the rate of field failures to zero.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 is an isometric view of the latch of the present invention shown installed on a gate in the closed position and engaged with the gate post.

FIG. 2 is an isometric view of the preferred embodiment of the latch of the present invention without the carriage bolts and cap nuts used during installation.

FIG. 3 is an isometric view of the preferred embodiment of the latch of the present invention shown with the carriage bolts, cap nuts, and lift lock used during installation.

FIG. 4 is a top view of the preferred embodiment of the latch of the present invention showing the carriage bolt and end cap as installed and the lift lock attached to the lower carriage bolt.

FIG. 5 shows the one piece manufacturing pattern of the latch of the present invention.

FIG. 6 is an isometric view of the secondary embodiment of the latch of the present invention shown with the carriage bolts, cap nuts, and lift lock used during installation.

### DETAILED DESCRIPTION OF THE INVENTION

The following description of the preferred embodiment(s) is merely exemplary in nature and is in no N intended to limit the invention, its application, or uses.

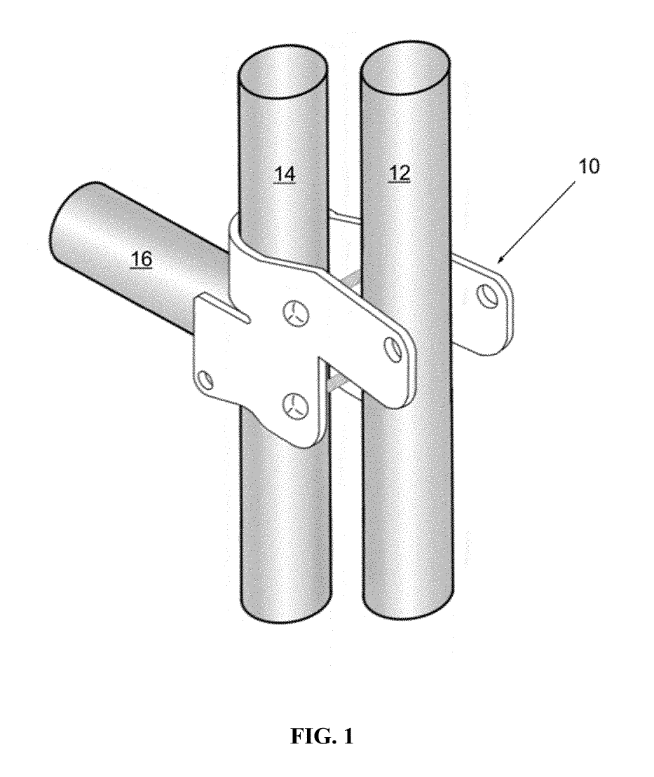

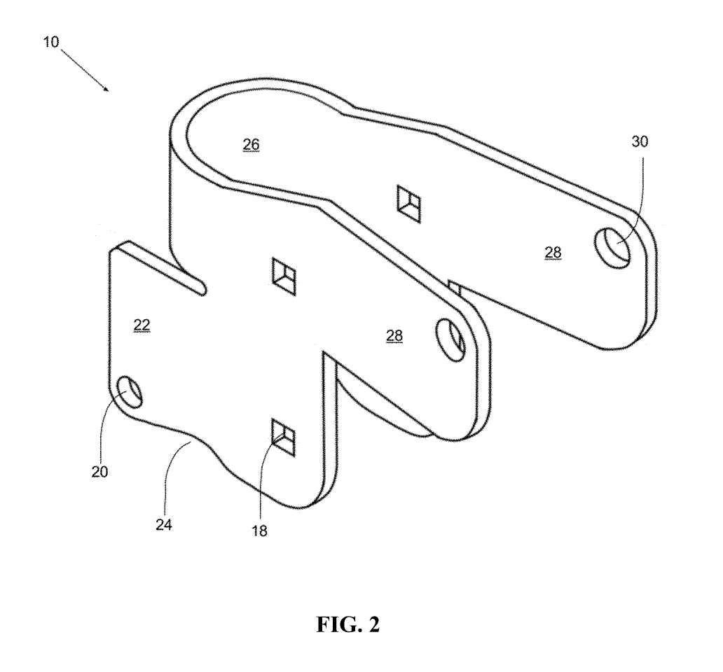

In order to best understand the latch of the present invention it is advantageous to first show the latch as it would appear on a gate before describing the individual features of the latch. FIG. 1 shows latch 10 of the present invention installed on gate 14 that is in a closed position and thus abutting gate post 12. Reference 14 identifies the gate but more particularly identifies the vertical metal tube at the far end of the gate opposite the vertical metal tube containing hinges that are used to support the swinging action of a gate. In addition to the vertical metal tubes at either end, a gate has three or more horizontal metal tubes forming a network with the two vertical tubes. Of the horizontal metal tubes, one is at the bottom of the gate, one is at the top of the gate, and depending upon the height or construction practice of the manufacturer one or more horizontal metal tubes exists between the top and bottom metal tubes. In FIG. 1 one such horizontal tube is labeled as crosstube 16 and latch 10 is designed to rest on crosstube 16 and slide along the vertical axis of gate 14. Gate post 12 is fixed in position and when the gate is closed gate post 12 is enclosed by latch 10. As latch 10 encloses both gate post 12 and crosstube 16 and gate port 12 is fixed the gate is prevented from swinging in either direction. We may not proceed to FIG. 2 which shows the individual features of latch 10.

In FIG. 2 the individual features of latch 10 are shown. Latch 10 is shown by itself without any associated component being displayed so as to better focus on the individual features of latch 10. As latch 10 appears in FIG. 2 it resembles, in a rough form, the letter “S”. The arm of the letter “S” corresponds to upper prongs 28 while the leg of the letter “S” corresponds to lower prongs 22. The spine of the letter “S” corresponds to lift guide 26 and gate 14 passes within lift guide 26. When a gate is closed latch 10 is in the position as shown in FIG. 1 with lower prongs 22 enclosed about crosstube 16 and upper prongs enclosed about gate post 12. Attempts to push open the gate results in an opposing force being applied to upper prong 28 facing the user by gate post 12. As latch 10 pivots clockwise in response to this force about lift guide 26 lower prong 22 facing the user will come into contact with crosstube 16 to limit the pivot movement of latch 10 thereby keeping the gate closed. Conversely, attempts to pull open the gate results in an opposing force being applied to upper prong 28 facing away from the user by gate post 12. As latch 10 pivots counter clockwise in response to this force about lift guide 26 lower prong 22 facing away from the user will come into contact with crosstube 16 to limit the pivot movement of latch 10 thereby keeping the gate closed. To open the gate latch 10 must be lifted so that lower prongs 22 clear crosstube 16 and then the user may push or pull the gate open as latch 10 will freely pivot without the interference of crosstube 16. As latch 10 pivots away from gate post 12 it is desirable for latch 10 be to in a position to receive gate post 12 with upper prongs 28 when the gate is closed. Latch 10 contains at its base an indentation, landing 24, so that as latch 10 pivots away from gate post 12 landing 24 will engage crosstube 16 to discourage further pivoting by latch 10. When the gate is closed, latch 10 will then be at the proper rotation to receive gate post 12 within upper prongs 28 without any assistance by the user.

There is found on each side of latch 10 four openings, two that are square and two that are circular. Square openings 18 are used during installation by carriage bolts 32 that pass through from one side of latch 10 to the opposing side of latch 10 and are secured by end caps 34. Square openings 18 must be square to accommodate carriage bolt 32. The two circular openings are not required to be circular and may be of any geometric shape. Lower circular opening 20 is provided to attach a device so that latch 10 may not be lifted from its rest position by clever animals. As the gap between lower prongs 22 and crosstube 16 is narrow, the device does not need to be large to stop lower prongs 22 from being lifted above crosstube 16 and allowing the gate to open. Upper circular opening 30 is provided to attach a padlock with a long shank to discourage theft of latch 10.

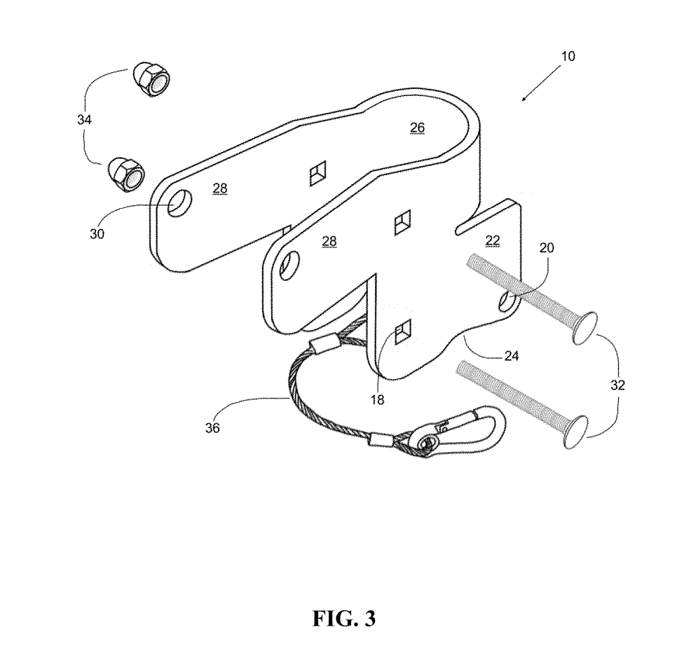

FIG. 3 shows latch 10 with all of its associated components. As compared to FIG. 2, the opposing side of latch 10 is shown so that it may be seen that all of the features shown on FIG. 2 also exist on the opposing side. The components used to mount latch 10 to gate 14 are carriage bolts 32 and end caps 34. Lift stop 36 is a device that may be installed with latch 10 to prevent clever animals from lifting latch 10 and thus opening the gate. In the preferred embodiment lift stop 36 is a short wire rope with an empty loop at one end and a loop having a carabiner permanently mounted at the opposing end. To prevent a clever animal from lifting latch 10 the carabiner may be clipped into lower circular opening 20 to fill the gap between lower prong 22 and crosstube 16. When latch 10 is lifted, unless the carabiner is unclipped from lower circular opening 20, lower prong 22 may not be raised to a height sufficient to clear the top of crosstube 16 thus ensuring that the gate remains closed. The empty loop is threaded through carriage bolt 32 during installation so that lift stop 36 remains as part of latch 10.

To mount latch 10 the user will first place latch 10 on crosstube 16 as shown on FIG. 1 so that both of the user's hands remain free for the remainder of process. Second, the user will insert carriage bolts 32 through square openings 18 so that gate 14 is enclosed by carriage bolts 32 and lift guide 26. If the user will be installing lift lock 36 they will need to pass lower carriage bolt 32 through the empty loop present at one end of lift stop 36. Finally, using a crescent wrench, user will tighten end caps 34 onto the ends of carriage bolts 32 and thus complete the installation. The installation is very simple, only takes a few minutes to complete, is accomplished by a single tool, and does not require any alignment with an associated component installed on gate post 12.

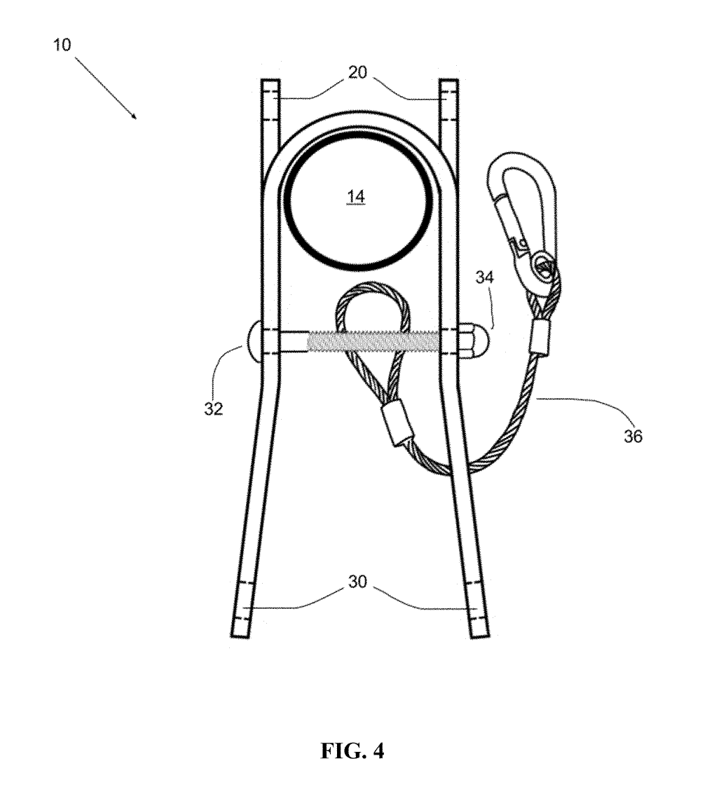

FIG. 4 shows a top view of latch 10 mounted about gate 14 with carriage bolts 32, end caps 34, and lift stop 36 installed. As the upper carriage bolt is directly above the lower carriage bolt only the upper carriage bolt is shown. Lift stop 36 is attached to latch 10 by passing the lower carriage bolt through lift stop's 36 open loop.

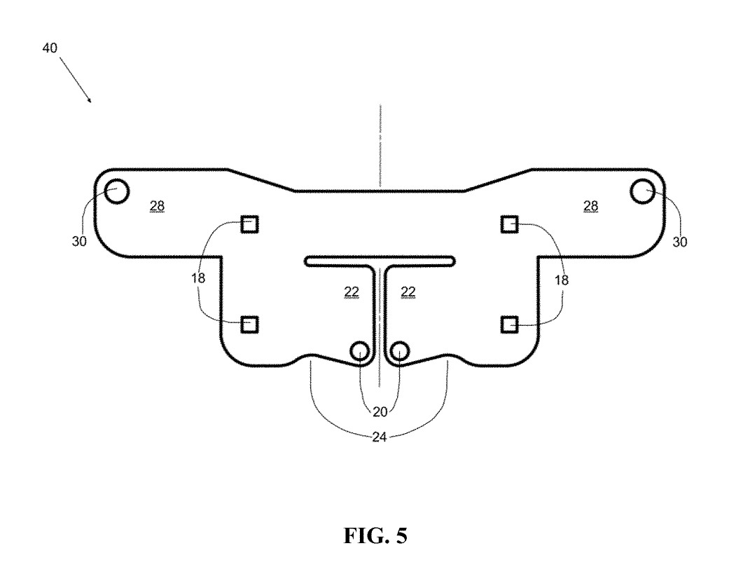

FIG. 5 shows pattern 40 used for cutting the metal when fabricating latch 10. To fabricate latch 10 pattern 40 is first cut from a sheet of source metal. Second, a first bending operation is performed along the axis of symmetry shown so that latch 10 appears as the letter “U” when viewed from the bottom or top. Finally, a second bending operation is performed to bend upper prong 28 outwardly to facilitate latch 10 receiving gate post 12. The ease of fabricating latch 10 leads to lower manufacturing costs as compared to other latches with fewer defects. In addition, the symmetry of latch 10 may be clearly seen about the indicated axis of symmetry. All of the features visible left of the axis of symmetry are also visible right of the axis of symmetry.

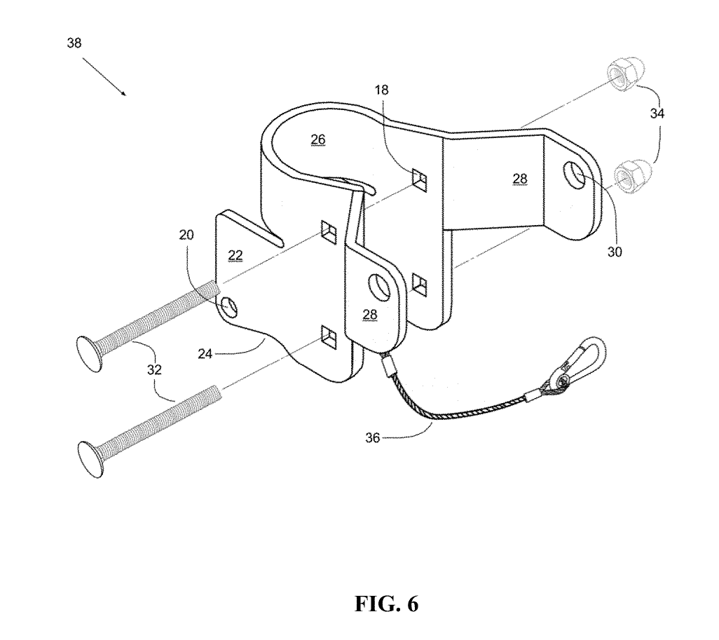

FIG. 6 shows an isometric view of a secondary embodiment of the present invention latch 38. In some gate installations, gate post 12 is rectangular rather than circular as shown in FIG. 1. To accommodate posts of such construction upper prongs 28 may be modified as shown in FIG. 6 to receive gate post 12 when the gate is closed. Other than the variation of upper prong 28, the remainder of latch 38 is identical to latch 10 even as to the use of pattern 40.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A gravity operated gate latch comprising:
a frame
formed roughly in the shape of the letter “U” when viewed from the top or bottom;
containing a plurality of symmetrical openings on either side wherein arms of the “U” engages the gate post,
base of the “U” receives the vertical tube of the gate opposing the gate post, and
flanges at the base of the “U” engages either side of a horizontal tube;
one or more bolts to pass through said openings; and
one or more nuts to secure said bolts.

2. The latch of claim 1 wherein said flanges contains at least one symmetrical openings to receive a device to prevent said latch from being lifted above said horizontal tube or from being stolen.

3. The latch of claim 2 wherein said device is a wire rope comprising a loop at one end and a carabiner at the opposing end where said loop is secured to said latch when threaded by said bolt and said carabiner is clipped or unclipped to said flange opening to respectively prevent or allow said latch from being lifted above said horizontal tube.

4. The latch of claim 2 wherein said device is a padlock.

5. The latch of claim 1 wherein said arms contains at least one symmetrical opening to receive a device to prevent theft of the latch.

6. The latch of claim 5 wherein said device is a padlock.

7. The latch of claim 1 wherein said flanges contain a symmetrical indentation to stop the pivoting of said latch as the gate is opened so that said latch may receive the gate post when the gate is closed without manual rotational adjustment.
